(19) United States
(12) Patent Application Publication
(10) Pub. No.: US 2024/0216215 A1
(43) Pub. Date: Jul. 4, 2024

(54) Tool to Control Sexual Devices

(71) Applicant: James May, Steilacoom, WA (US)

(72) Inventor: James May, Steilacoom, WA (US)

(21) Appl. No.: 18/529,163

(22) Filed: Dec. 5, 2023

Related U.S. Application Data
(60) Provisional application No. 63/386,225, filed on Dec. 6, 2022.

(51) Int. Cl. A61H 19/00

(52) U.S. Cl. CPC A61H 19/44; A61H 2201/0119; A61H 2201/164; A61H 2201/5053

(57) ABSTRACT

The Tool to Control Sexual Devices is an apparatus comprising: 1) an at least one handle, which is a solid mass of suitable size and shape which provides an easy and comfortable means for a user to move and position an at least one nucleus and thereby move and position an at least one sexual device, comprising a vibrator, a dildo, a dong, or a plug, with at least one Legs, in a manner which can provide gratifying sexual stimulation, and 2) an at least one nucleus, which is a solid mass of suitable size and shape and functions as a means to transmit motion from the at least one handle to the at least one sexual device, and 3) an at least one fulcrum, which is a solid mass of suitable size and shape and functions as support for the nucleus on which the nucleus can pivot.

### CROSS-REFERENCE TO RELATED APPLICATIONS

Provisional patent having application No. 63/386,225 filed Dec. 6, 2022

### BACKGROUND OF THE INVENTION

Current U.S. The applicable U.S. patent classification to which the invention pertains is 600/38.

Current CPC Class A61H 19/00, A61H 19/30, A61H 19/34, A61H 19/40, A61H 19/50, A61H 21/00

Current Int. Cl. A61H 21/00 Sexual devices A61F 5/00

U.S. patents by patent number, issue date and inventor(s);

| | | |
|---|---|---|
| 4,790,296 | Dec. 13, 1988 | Segal |
| 5,690,604 | Nov. 25, 1997 | Barnett |
| 5,725,473 | Mar. 10, 1998 | Taylor |
| 6,899,671 | May 31, 2005 | Fontenot |
| 6,991,599 | Jan. 31, 2006 | Hudson |
| 7,993,262 B2 | Aug. 9, 2011 | Cianfrani |
| 8,313,424 | Nov. 20, 2012 | Gabrielidis |
| 8,876,695 | Nov. 4, 2014, | Wilson, et al |
| 9,022,924 | May 5, 2015 | Thrasher |

### DESCRIPTION OF PRIOR ART

Since prehistoric times, humans have sought gratifying sexual stimulation. This quest has given rise to the invention of hand held sexual devices, comprising manual ones such as dildos and plugs, and electric ones such as vibrators. The stimulation these sexual devices provide can depend in large measure on their being positioned against or into human genitalia or the anus and moved. Positioning and movement may be accomplished in a number of ways including but not limited to: 1) the assistance of another person, 2) using one's own hands, 3) attaching the sexual devices to a door, post, chair or other stationary object, 4) incorporating the sexual devices into other complicated and expensive devices, 5) strapping the sexual devices to the user, 6) using one's own Legs, (where throughout this document Legs is defined as comprised of those parts of the human body including and extending from the hips to and including the toes), and 7) any permutation of these ways.

The problem with obtaining the assistance of another person is that a suitable person may not be available.

Examples of a sexual apparatus requiring the use of hands are U.S. Pat. No. 6,991,599, Jan. 31, 2006, Hudson, Personal exercise system, U.S. Pat. No. 9,022,924, May 5, 2015, Thrasher, Hand-held platform for a phallic device, and U.S. Pat. No. 8,313,424, Nov. 20, 2012, Gabrielidis, Sex Toy.

The problem with using one's own hands is that they become unavailable for other uses.

Examples of attaching the sexual devices to a door, post, chair, or other stationary object are U.S. Pat. No. 5,690,604, Nov. 25, 1997, Barnett, Sexual appliance having a phallic device and a device for mounting the same onto a support structure, and U.S. Pat. No. 7,993,262 B2, Aug. 9, 2011, Cianfrani, Stimulatory device support apparatus. A problem with attaching a sexual device to a stationary object is that the sexual devices' direction, range and duration of movement are very limited.

Examples of incorporating the sexual devices into other complicated and expensive devices are U.S. Pat. No. 5,725,473, Mar. 10, 1998, Taylor, Sexual aid, and U.S. Pat. No. 4,790,296, Dec. 13, 1988, Segal, Sexual stimulation apparatus.

The problem with attaching the sexual devices to other complicated and expensive devices is that this is expensive, and the devices become heavy and difficult to store. Of course, discrete storage of sexual devices is advantageous.

An example of strapping the sexual devices to the user is U.S. Pat. No. 8,876,695, Nov. 4, 2014, Wilson, et al Foot sleeve dildo harness. Some problems with strapping the sexual devices to the user are continuous use becomes rapidly strenuous, positioning is problematic, and gratifying movement is problematic.

An example of a patent which utilizes Legs to maneuver a sexual device is U.S. Pat. No. 6,899,671, May 31, 2005, Fontenot, which requires a “Y” shaped tubular assembly having two adjustable articulated arms and one extendable arm.

### BRIEF SUMMARY OF THE INVENTION

An invention is a solution to a specific technological problem and is a product or a process. The technological problem this invention solves is how to position and manipulate what is usually thought of as a hand held sexual device in a gratifying manner without the use of: 1) the assistance of another person, 2) using one's own hands, 3) attaching the toys to a door, post, chair or other large, stationary base, 4) attaching the sexual device to other complicated and expensive devices, or 5) strapping the sexual device to the user.

The solution this invention presents is to use one's Legs to maneuver the Tool to Control Sexual Devices, which in turn maneuvers the sexual device.

Since human Legs are in closer proximity to their genitals than are their arms, and since human Legs are typically stronger than their arms, and less susceptible to fatigue, the Legs are a very good choice to use for positioning and moving sexual devices for the purpose of experiencing sexual stimulation.

The Tool to Control Sexual Devices comprises 1) an at least one fulcrum, 2) an at least one handle and 3) an at least one nucleus, which has physical features for the connection of an at least one sexual device to it, and has physical features for the connection of an at least one handle; although, the at least one fulcrum, and/or the at least one handle may be manufactured as a portion of the nucleus.

After the at least one nucleus, the at least one fulcrum, the at least one handle, and the at least one sexual device, are manufactured and assembled, the user lies on his or her back on a supporting surface and positions the apparatus between his or her Legs, then drapes his or her Legs over the at least one handle. This configuration greatly enhances the ease and comfort with which Legs can be used to control an at least one sexual device, and frees up hands for other uses.

### BRIEF DESCRIPTION OF THE SEVERAL VIEWS OF THE DRAWING

FIG. 1 depicts a top view of the major components of the preferred embodiment (the preferred embodiment, as used herein, is comprised of the best mode) of the Tool to Control Sexual Devices as described in the section Brief Summary of the Invention above: a fulcrum 1, a nucleus 2, and a handle 3, together with several holes passing through two of the major components as shown: lashing hole 4, lashing hole 5, nucleus bolt hole 6, and fulcrum bolt hole 7.

FIG. 2 depicts a side view of the assembled major components together with a sexual device 8 over which an O ring 9 has been slid and positioned adjacent to the sexual device base 10.

FIG. 3 depicts a view of the use of the preferred embodiment connected to the sexual device 8. The use of the preferred embodiment connected to the sexual device 8 contemplates a user lays on his or her back on a supporting surface 10, positions the preferred embodiment connected to the sexual device 8 between his or her Legs, and drapes his or her Legs over the Handle 3.

### DETAILED DESCRIPTION OF THE INVENTION

The Tool to Control Sexual Devices is a tool, akin to a handle, which connects to an at least one sexual device and facilitates the positioning and movement of the at least one sexual device by Legs; although, positioning and movement of the Tool to Control Sexual Devices by hand(s) or other means is also feasible, although less convenient.

### Process of Making and Using the Preferred Embodiment of the Tool to Control Sexual Devices.

The preferred embodiment contemplated by the inventor of carrying out the invention is set forth below. The preferred embodiment does not limit the Tool to Control Sexual Devices, but rather illustrates one of many products which satisfy the description of the Tool to Control Sexual Devices as set forth in the Brief Summary of Invention above.

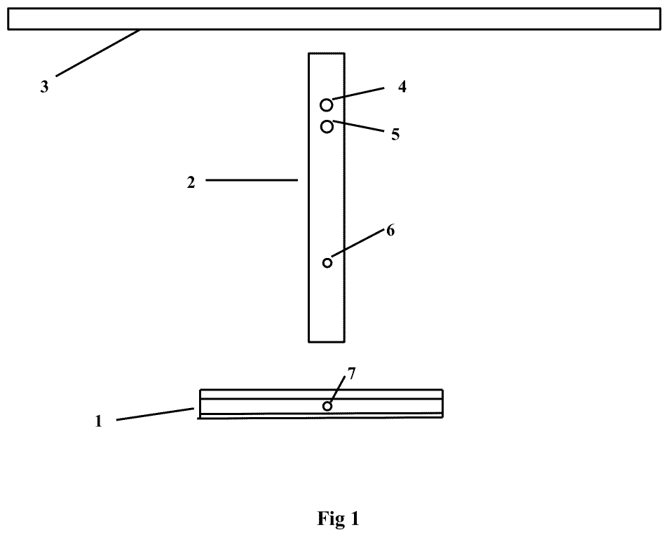

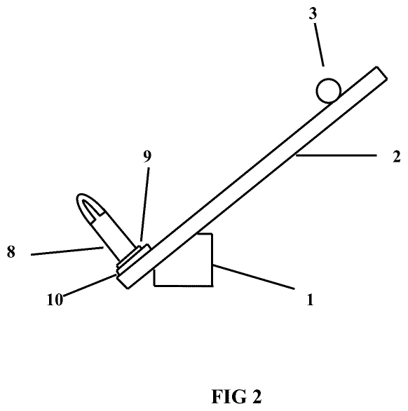

The major components of the preferred embodiment of the Tool to Control Sexual Devices contemplated by the inventor of carrying out the invention are comprised of a fulcrum, a nucleus, and a handle. The fulcrum is a smooth sixteen inch long piece of 4 inch by 4 inch lumber, which has been cut into the shape depicted by fulcrum 1 in FIG. 1 and FIG. 2, and through which a bolt hole has been drilled as depicted by fulcrum bolt hole 7 in FIG. 1. The fulcrum bolt hole 7 may be counter sunk to prevent a bolt head or nut from protruding through the fulcrum. The nucleus is a smooth twenty inch long 2 inch by 4 inch piece of lumber through which two lashing holes (lashing hole 4 and lashing hole 5) and one bolt hole (nucleus bolt hole 6) have been drilled, as depicted by FIG. 1. The nucleus bolt hole 6 may be counter sunk to prevent a bolt head or nut from protruding through the nucleus. The handle is a thirty six inch long by one and a half inch diameter smooth wood rod depicted by handle 3 in FIG. 1.

Assembly begins by positioning fulcrum 1 and nucleus 2 as depicted in FIG. 2, then sliding a bolt through nucleus bolt hole 6 and fulcrum bolt hole 7 and securing the bolt with a nut, thereby bolting nucleus 2 to fulcrum 1.

Assembly continues by attaching handle 3 to nucleus 2. Handle 3 is positioned pependicular to nucleus 2 as depicted in FIG. 2, then lashed to nucleus 2 with a tie down strap. The tie down strap has two ends, one end is bare and the other end is connected to a buckle cam. Lashing is achieved by feeding the bare end of the tie down strap down through lashing hole 4, wrapping the tie down strap around handle 3, feeding the bare end of the tie down strap back up through lashing hole 5, and tightening the strap by feeding the bare end through the cam buckle of the tie down strap, then pulling tight to remove the slack.

The sexual device chosen for the preferred embodiment is a dildo having a base larger than its shaft. The sexual device 8 is attached to the preferred embodiment in the following manner. An O ring 9, larger than the shaft of sexual device 8 and smaller than the sexual device base 10 is slid over the shaft of sexual device 8 and against the sexual device base 10, which prevents the O ring 9 from sliding off the base end of the shaft. The bare end of a one inch wide cam buckle tie down strap is fed down through a gap between the inside of O ring 9 and the shaft of the sexual device 8. Sexual device 8 is then positioned on the nucleus 2 as depicted in FIG. 2. The tie down strap is then wrapped around nucleus 2 and the bare end fed back up through O ring 9. Lashing concludes with feeding the bare end of the tie down strap through the cam buckle on the other end of the tie down strap, then pulling the tie down strap tight to remove the slack.

The nucleus, fulcrum, and handle may be any weight which is convenient to maneuver. The nucleus, fulcrum, and handle may be made of wood, plastic, rubber or other solid material; provided the density of the material does not make the nucleus a stationary object significantly limiting the ability to position and move it. Except for holes as shown in the drawings, the nucleus and fulcrum are solid; although, other embodiments contemplate other voids, for example, voids which serve to reduce material and weight, and voids through or into which a handle or a sexual device might be slid.

The positioning of the major components of the preferred embodiment as thus assembled is illustrated in FIG. 2. After the preferred embodiment is assembled, it is connected to the at least one sexual device 8. An example of a sexual device 8 is shown positioned on the preferred embodiment in FIG. 2.

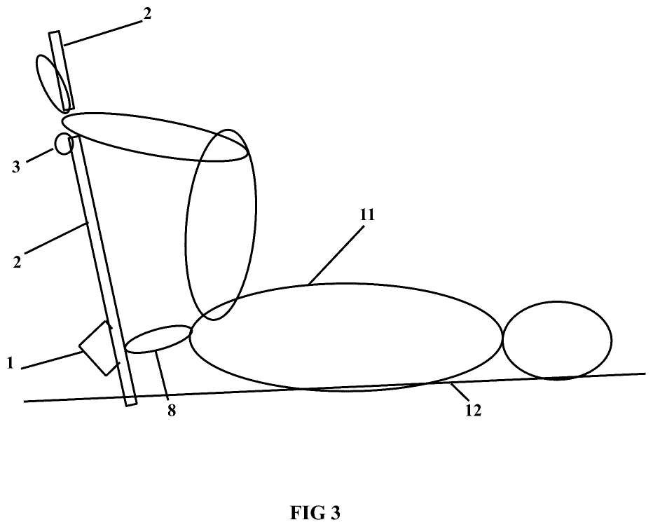

Preferred embodiment use contemplates the preferred embodiment of the invention be connected to a sexual device 8 of choice and placed on a supporting surface 10 between the user's Legs in close proximity to the Torso 11 (where Torso 11 is defined as the human body, except the Legs) while the user is prone on his or her back, such as is set forth in FIG. 3. Once placement of the preferred embodiment is achieved, the user will move his or her Legs and thereby move the sexual device 8 in a manner which produces sexual gratification. The user may also move his or her Torso 11 against, over, under, around, or through the sexual device 8, in a manner which produces sexual gratification.

1. I claim invention of an apparatus comprising:
an at least one handle, which is a solid mass of suitable size and shape and which provides an easy and comfortable means for a user to move and position an at least one nucleus and thereby move and position an at least one sexual device, comprising a vibrator, a dildo, a dong, or a plug, with his or her at least one Legs, in a manner which can provide gratifying sexual stimulation; and
an at least one nucleus, which is a solid mass of suitable size and shape and functions as a means to transmit motion from the at least one handle to the at least one sexual device, and
an at least one fulcrum, which is a solid mass of suitable size and shape and functions as support for the nucleus on which the nucleus can pivot,
which, when manufactured and or assembled, enables a user to move the at least one handle, with an at least one part of an at least one of his or her Legs and thereby move the at least one sexual device;
with the caveats that to clearly avoid prior art, the apparatus comprises
no “Y” shaped tubular assembly having two adjustable articulated arms and one extendable arm, which is an essential element of U.S. Pat. No. 6,899,671 May 31, 2005 Fontenot, and
no pivotal connection between a first elongate member and a second elongate member such that compression and decompression of said first elongate member toward and away from said second elongate member with an operator's Legs produce longitudinal movement of a stimulating member in an inwardly direction into an orifice and then an outwardly opposite direction within said orifice.

2. Components separate and distinct. I claim invention of an apparatus comprising claim 1 plus the at least one handle, the at least one nucleus, the at least one fulcrum, and the at least one sexual device are each separate, individual and readily distinguishable components, which can be appropriately attached to each other and assembled by viable, common means.

3. Nucleus and fulcrum one. I claim invention of an apparatus comprising claim 2 except the at least one nucleus, and the at least one fulcrum are not separate components, but rather are manufactured as one part.

4. Handle and nucleus one. I claim invention of an apparatus comprising claim 2 except the at least one handle, and the at least one nucleus are not separate components, but rather are manufactured as one part.

5. Handle, and fulcrum one. I claim invention of an apparatus comprising claim 2 except the at least one handle, and the at least one fulcrum are not separate components, but rather are manufactured as one part.

6. Handle, nucleus and fulcrum one. I claim invention of an apparatus comprising claim 2 except the at least one handle, the at least one nucleus, and the at least one fulcrum are not separate components, but rather are manufactured as one part.

7. Nucleus and sexual device one. I claim invention of an apparatus comprising claim 2 except the at least one nucleus, and the at least one sexual device are not separate components, but rather are manufactured as one part.

8. Handle and sexual device one. I claim invention of an apparatus comprising claim 2 except the at least one handle, and the at least one sexual device are not separate components, but rather are manufactured as one part.

9. Fulcrum, and sexual device one. I claim invention of an apparatus comprising claim 2 except the at least one fulcrum, and the at least one sexual device are not separate components, but rather are manufactured as one part.

10. Nucleus, handle, fulcrum and sexual device one. I claim invention of an apparatus comprising claim 2 except the at least one nucleus, the at least one handle, the at least one fulcrum, and the at least one sexual device are not separate components, but rather are manufactured as one part.
